(19) United States
(12) Patent Application Publication
(10) Pub. No.: US 2018/0051827 A1
(43) Pub. Date: Feb. 22, 2018

(54) MAGNETIC LOOP HANGER

(71) Applicant: Barton L. GARVIN, Western Springs, IL (US)

(72) Inventor: Barton L. GARVIN, Western Springs, IL (US)

(21) Appl. No.: 15/239,129

(22) Filed: Aug. 17, 2016

(51) Int. Cl. F16L 3/14; F16B 1/00; H01F 1/03; H01F 7/02; H02G 7/05

(52) U.S. Cl. CPC F16L 3/14; F16B 1/00; F16B 2001/0035; H01F 7/0221; H02G 7/053; H01F 1/0306

(57) ABSTRACT

The present invention is a magnetic loop hanger for hanging common hanging members in a construction zone, including but not limited to, electrical wires, cables, pipe or conduit to a suitable magnetically engageable surface. The magnetic loop hanger comprises a helical looped wire member or a spiral wire member with a first end and a second end and a pitch between the first and second end, an elongated member having a proximal end and a distal end, the proximal end extending from the second end, an enlarged mounting member formed to the distal end, and at least one magnet coupled to the mounting member. The magnetic loop hanger is magnetically engaged to a suitable magnetically engageable surface. The suitable magnetically engageable surface may include a drop ceiling frame, an I-beam, a truss, a scaffold, a pipe, a vent, a duct, or a sconce.

### CROSS-REFERENCE TO RELATED APPLICATIONS

This application is related to co-pending U.S. Design patent application Ser. No. 29/563,886 filed May 9, 2016.

### BACKGROUND OF THE INVENTION

The present invention relates to a mechanical device to support items such as, but not limited to, electrical wires, cables, piping and conduit from suitable magnetically engageable surfaces. More specifically, the invention is primarily intended to provide an installer such as an electrical contractor a one piece hanger to directly mount to suitable magnetically engageable surfaces including but not limited to a drop ceiling frame, an I-beam, a truss, a scaffold, piping, vents, ducts, and sconces, without the need for penetrating fasteners to secure the mechanical device to a support structure.

In the electrical industry, open loop shaped wire hangers for overhead use are commonly referred to as “bridle rings.” These bridle rings are a wire formed product comprising a loop with a fastening leg extending from the loop, the fastening leg may be threaded or may be configured to accept a nail, bolt, screw or other fastener, to secure the bridle ring to a supporting structure or mounting surface. The loop supports the wire while the fastening leg is installed into or onto the mounting surface such as a ceiling or a wall. As the industry practice utilizes a threaded leg, the bridle ring must be fastened to numerous installation accessories to properly mount it to the surface. In particular, to mount a bridle ring, a rod anchor pin and a rod coupler must be utilized along with a surface hole or insert.

Because of these numerous installation accessories used in the current state of the art, mounting a bridle ring to support wires requires very labor intensive and costly steps to install. First, the installer must drill a hole or insert into the mounting surface such as the ceiling or the wall. Next, the installer must install a rod anchor containing a female thread into the hole. Then the installer must thread a rod coupler into the anchor pin to provide a mount for the bridle ring. Next, the installer threads the bridle ring into the rod coupler. After, installation, the installer must retrieve the wire from a wire puller located at a distance away from the bridle ring. The installer then must proceed to carry the wire to the bridle ring and insert it through the installed bridle ring.

As in many electrical jobs, these bridle rings are installed at a height requiring a ladder or a scaffold. Thus, this multi-step process is further encumbered by having to descend and ascend the ladder/scaffold to install the accessories and to install the bridle ring. After installation, the installer must descend from the location to retrieve and pull the wire for each needed location of the bridle ring and pull the wire back up the ladder/scaffold through the bridle ring.

In the present state of the art, a hanger does not exist to economically and efficiently support electrical wire in a one-step installation while allowing an installer to repetitively install hangers without stopping to insert accessories or pull wire. Currently, loop shaped supports exist for supporting or hanging tubular members such as a wire. In particular, U.S. Pat. No. 5,022,614 issued to Rindeerer discloses a one piece conduit clip for securing conduit and the like to channel framing. The channel framing is commonly used in the industry and contains hook shaped lips at the ends of outer sides of the channel. These lips define a slot extending lengthwise of the channel. The slot opens downwardly when the channel is mounted in a ceiling and opens laterally when the channel is mounted on a side wall.

The clip comprises a one piece U-shaped clip with planar legs extending down away from the U-shaped opening with a connecting portion connecting the legs to each other. The U-shaped opening contains feet at each side which overlap inside the channel to slot inside the channel ridge holding the clip by pressure force to the channel member. Electrical cable is then slotted through the clip to be held at the desired height of the channel.

As with the existing bridle rings, limitations exist with respect to the conduit clip. Although the clip is a one piece member which can be installed in a convenient succession, the clip cannot be directly installed to a surface such as a drop ceiling frame, an I-beam, a truss, a scaffold, piping, vents, ducts, and sconces. The clip can only be installed to a channel which requires mounting to the surface. Mounting the channel requires labor intensive steps to properly prepare the surface insert and fasten the channel at numerous locations along the surface. Further, the clip has to be mounted individually to the channel. Thus, numerous costly steps are required to mount the clip to the channel.

U.S. Pat. No. 3,995,822 issued to Einhorn discloses a swivel hook with pivotable components. The swivel hook comprises a yoke with a hook pivotally mounted to the yoke. The yoke is a U-shaped member joined by a bridge extending across which mounts to a surface. In an alternative embodiment, the yoke contains a mounting hole defined therein where a screw can be inserted for mounting the swivel hook directly to a surface. Still, further, in another embodiment, a screw is affixed to the back portion of the yoke which can be directly screwed into a mounting surface. This swivel hook also contains limitations though because again, mounting to a metal surface such as duct or pipe may compromise the integrity of said surfaces and cause gas and fluid leakage.

It would become highly economical to eliminate the extensive time, labor and material currently needed to mount bridle rings commonly used in the electrical industry. This cumbersome and inefficient method would be eliminated by a quick succession of movements.

It would become highly advantageous to provide a device that can efficiently, quickly and economically support electrical wires by directly mounting to a suitable magnetically engageable mounting surface. It further becomes highly advantageous to directly mount the device by using a magnet.

Accordingly, it is a principal object of the invention to provide a bridal loop device to directly mount to suitable magnetically engageable surfaces, including but not limited to, a drop ceiling frame, an I-beam, a truss, a scaffold, piping, vents, ducts, and sconces.

### SUMMARY OF THE INVENTION

The present invention pertains to a magnetic loop hanger for hanging common construction elements, including but not limited to, electrical wires, cables, pipe or conduit during construction and prior to permanent placement. The present invention can be comprised of a multitude of materials including but not limited to galvanized metal and a magnet. The magnet gives an installer the ability to hang construction elements from a suitable magnetically engageable surface without having to damage that suitable magnetically engageable surface.

The magnet also gives the installer the flexibility to move or rearrange already hung construction elements simply by pulling the device off of the surface and placing it elsewhere without needing any tools.

The terms “helix” or “helical” in this specification are meant to describe a curve or line traced along a cylinder. It is to be understood that the transverse cross section of the cylinder may be any shape, including but not limited to, circular, elliptical, triangular, square, rectangular, polygonal, or irregular polygonal. The term “spiral” in this specification is meant to describe the winding or revolution of a curve around a center point and the wind shape may be any shape, including but not limited to, circular, elliptical, triangular, square, rectangular, polygonal, or irregular polygonal. The use of the term “wire” is intended to encompass not only elongate cylindrical structures, but also to include elongate structures of varying transverse cross-sectional profiles, such as square, rectangular, trapezoidal, elliptical, oval, or other polygonal or irregular transverse cross sectional profiles and may include ribbon-like materials, planar-type materials such as bars or sheets, or such other structural members as will be configured to affix to a support structure, form a helical or spiral loop adapted for holding a wire or wire bundle and an elongate member adapted to space the helical or spiral loop apart from the support structure.

One embodiment of the magnetic loop hanger comprises a helical wire member with a first end and a second end. The helical wire member comprises a pitch or spaced apart opening between the first end and second end such that a hanging member, including but not limited to, wire, piping or conduit, may fit within the pitch. The helical wire member additionally comprises an inner diameter or radius such that a hanging member may be bound by the inner diameter. The magnetic loop hanger additionally comprises an elongated member having a proximal end and a distal end, the proximal end extending from the second end of the helical wire member. Extending from or formed to the distal end of the elongated member, is an enlarged mating member. The mating member is configured to be coupled to a magnet and lay sub-flush the surface of the magnet. The exposed surface area of the magnet is configured to engage with and attach to a suitable magnetically engageable surface.

In another embodiment instead of a helical wire member, the magnetic loop hanger comprises a wire member formed into a spiral or a nautilus spiral with a starting end and a finishing end. The starting end comprises an open end at the inner most portion of the spiral. The wire member winds and revolves about a center point or inner starting point of the spiral at a radius and pitch separating and creating an opening between curve elements of the spiral shape creating an innermost revolution and successive revolutions. The opening is formed by the pitch in between the second end or ending point at the outermost revolution and the next inner curved element or next inner revolution or successive revolution. The inner most revolution of the wire member is configured such that a hanging member may fit within the pitch and be supported by the inner most curve.

In an additional embodiment, the second end joins the elongate member and forms an angle between zero degrees and ninety degrees at the junction relative to a longitudinal axis of the elongated member.

In an additional embodiment, the second end joins the elongate member and forms an angle between zero degrees and negative ninety degrees at the junction relative to a longitudinal axis of the elongated member.

In another embodiment, at least two magnets are coupled to the mating member at complimentary angles such that the magnets are configured to engage a curved surface such as a pipe or scaffold in two places along the curve.

In another embodiment, at least a U-shaped magnet is coupled to the mating member such that the magnet is configured to engage a curved surface such as a pipe or scaffold in two places along the curve.

In another embodiment, at least a curved magnet is coupled to the mating member such that the magnet is configured to engage a curved surface such as a pipe or scaffold.

In another embodiment, multiple magnetic loop hangers are used to mount hanging members across a defined distance or path.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1A is a perspective view of the magnetic loop hanger.

FIG. 1B is a bottom perspective view of the magnetic loop hanger.

FIG. 2A is a perspective view of the magnetic loop hanger.

FIG. 2B is a side view of the magnetic loop hanger.

FIG. 2C is a top view of the magnetic loop hanger.

FIG. 3A a perspective view of the magnetic loop hanger.

FIG. 3B is an end view of the magnetic loop hanger.

FIG. 4A is a perspective view of the magnetic loop hanger.

FIG. 4B is a bottom perspective exploded assembly view of the magnetic loop hanger.

FIG. 4C is a bottom perspective view of the magnetic loop hanger.

FIG. 5 is a perspective view of the magnetic loop hanger joined to a metal structural member.

### DETAILED DESCRIPTION OF THE PREFERRED EMBODIMENTS

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

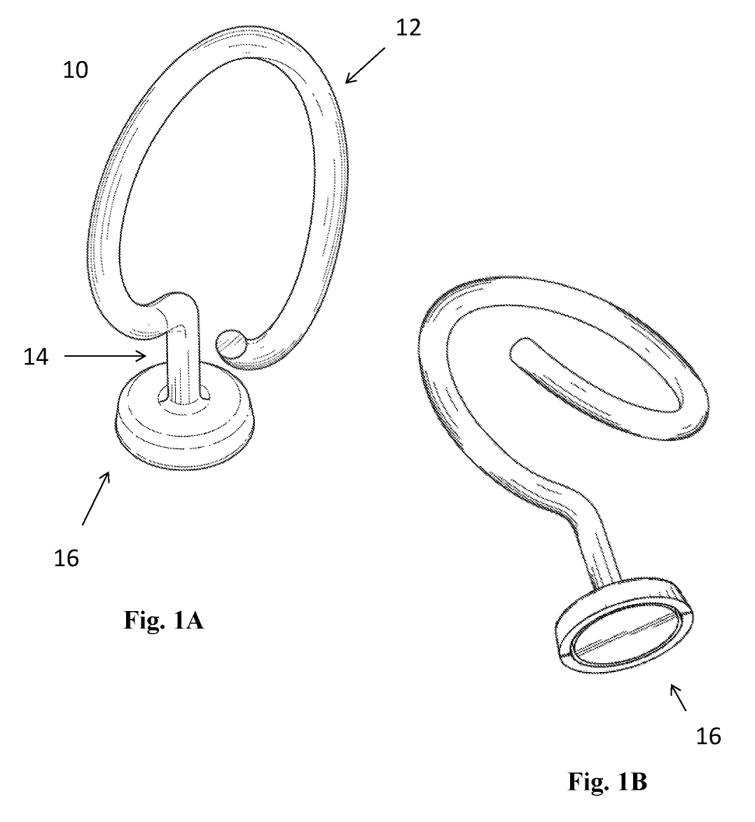

FIGS. 1A and 1B are perspective views of a magnetic loop hanger 10. The magnetic loop hanger 10 comprises a helical looped wire member 12, an elongated member 14, an enlarged mounting member 16, and at least one magnet 18.

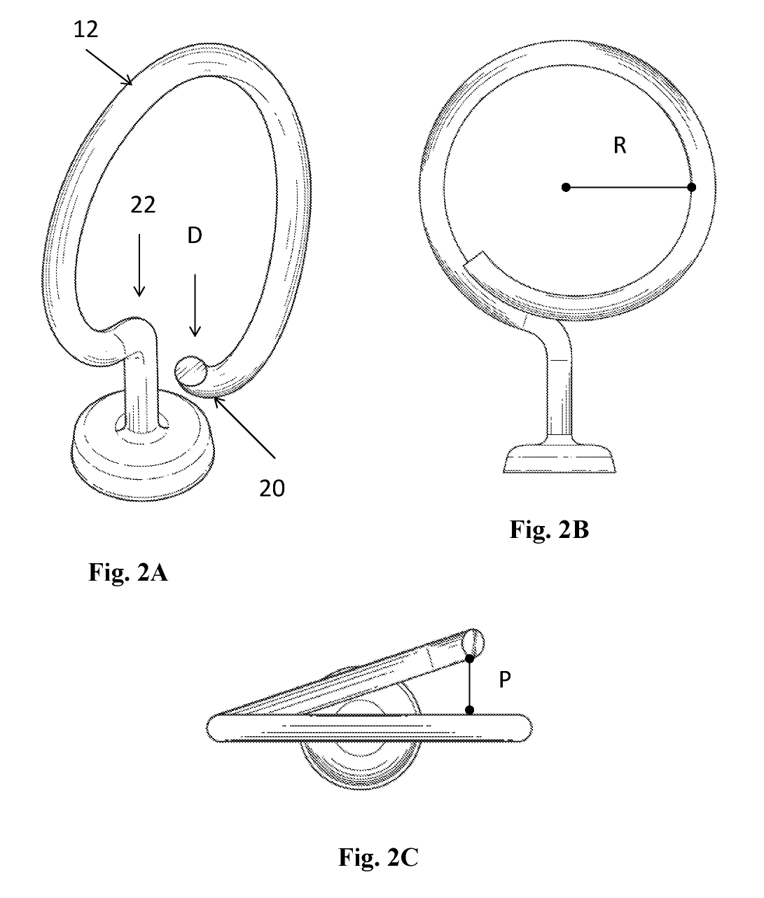

As further detailed in FIGS. 2A-2C, the helical looped wire member 12 comprises a first end 20 and a second end 22, a wire diameter D, as well as a loop radius R, central transverse axis CTA, and a pitch P or spaced apart opening between the first end 20 and the second end 22. The pitch P, the loop radius R, and the wire diameter D may be configured at varying lengths to accommodate the size and weight of a hanging member such as an electrical wire, a cable, a rope, a pipe, or a piece of conduit.

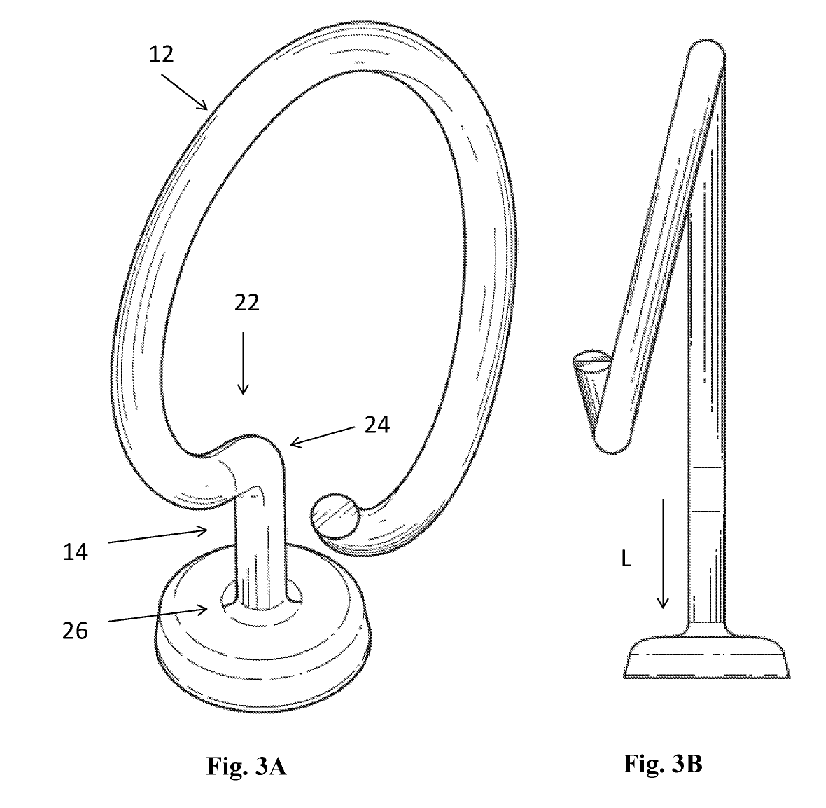

As further detailed in FIG. 3, the elongated member 14 is shown extending from the second end 22 of the helical looped wire member 12. The elongated member 14 comprises a proximal end 24 and a distal end 26. The proximal end 24 joins to the second end 22 of the helical looped wire member 12. The elongated member extends from the second end 22 along a longitudinal axis L. In one embodiment, the second end 22 joins the proximal end 24 at a 90 degree angle. In another embodiment, the second end 22 joins the proximal end 24 at a 0 degree angle.

In another embodiment, instead of a helical looped wire member 12, the magnetic loop hanger 10 comprises a wire member formed into a spiral or a nautilus spiral with a starting end and a finishing end. The starting end comprises an open end at the inner most portion of the spiral. The wire member winds and revolves about a center point or inner starting point of the spiral at a radius and pitch separating and creating an opening between curve elements of the spiral shape creating an innermost revolution and successive revolutions. The opening is formed by the pitch in between the second end or ending point at the outermost revolution and the next inner curved element or next inner revolution or successive revolution. The inner most revolution of the wire member is configured such that a hanging member may fit within the pitch and be supported by the inner most curve.

In one embodiment, the helical looped wire member or spiral wire member 12 and the elongated member 14 are preferably formed from the same wire and comprise the same wire diameter D. The wire material is preferably made of metal, but may, alternatively, be made of plastic, carbon fiber, composite, or combinations thereof. It will be understood by those in the art that alternative constructions of the helical looped or spiral wire member 12 and the elongated member 14 are also intended by the present invention. For example, the helical looped or spiral wire member 12 may be composed of single piece construction or may be made of multiple components joined together to form the helical loop structure. Additionally, the elongated member 14 may be of single piece construction itself or may be made of multiple components joined together to form the elongated member 14. Additionally, the elongated member 14 may be made of single piece construction with the helical looped wire member or spiral wire member 12 or may be a separate piece therefrom.

In embodiments where the elongated member 14 and the helical looped wire member or spiral wire member 12 are separate components, the two separate components may be joined in a multitude of ways, including but not limited to, a joining pin, a joining screw, or a junction bracket. These embodiments also may include adjustments for length of the separating distance, including but not limited to, a locking mechanism or joining bracket configured to allow the helical looped or spiral wire member 12 and the elongate wire member 14 to translate in a longitudinal direction relative to each other and be locked in place at the desired separation length and translated position.

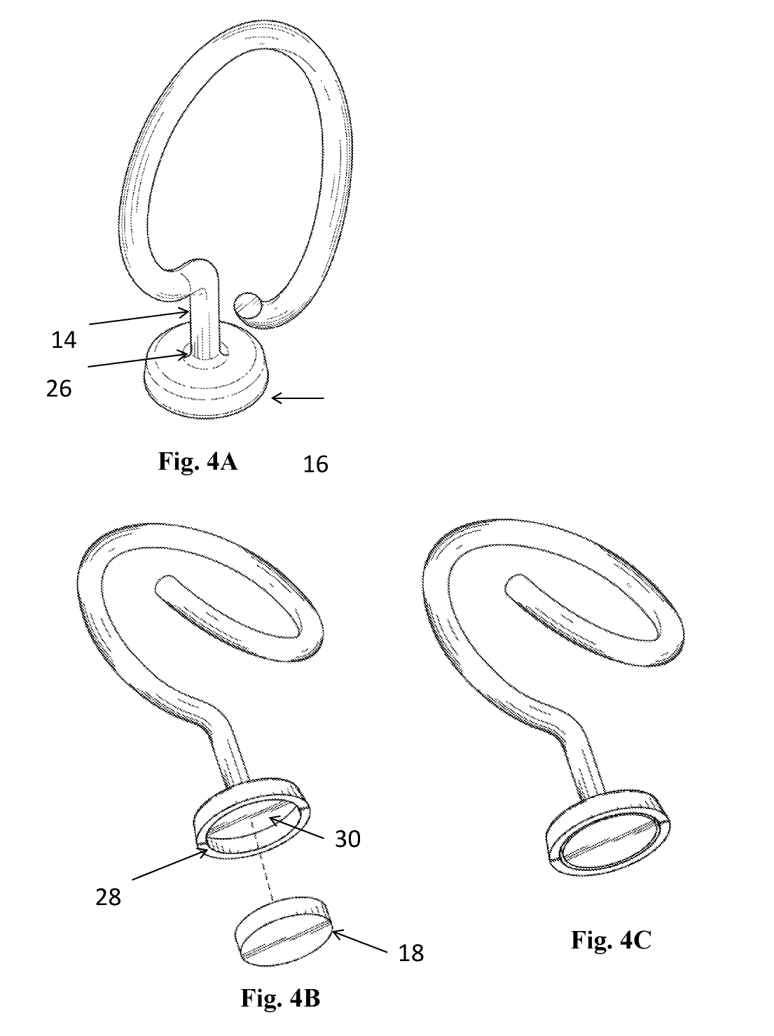

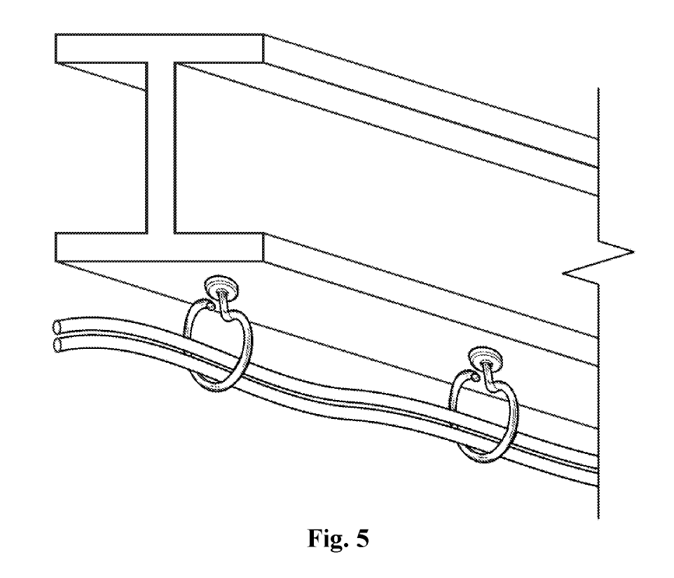

As further detailed in FIGS. 4A-C, the mounting member 16 is joined to the distal end 26 of the elongated member 14. The mounting member 16 is configured to house the at least one magnet 18. In the embodiment presented in FIGS. 4A-C, the mounting member 16 is circular with a recessed pocket 28. The at least one magnet 18 is coupled to the recessed pocket 28 such that a bottom surface 30 of the mounting member is sub-flush the depth of the at least one magnet 18. The shape of the mounting member 16 is not meant to be limited to a circle, but rather any shape that may house a magnet 18 of a complimentary shape. The at least one magnet 18 may be coupled magnetically or through an adhesive layer.

In another embodiment, the mounting member 16 may be comprised of at least two recessed pockets 28, to accommodate at least two magnets 18. In this embodiment, an angle A is created between respective mating surfaces of the at least two magnets 18 such that the at least two magnets 18 may magnetically engage at two points on a curved surface such as a pipe or scaffold.

In another embodiment, the mounting member 16 may be comprised of a recessed pocket 28, configured to accommodate at least a U-shaped magnet 18. In this embodiment an angle A is created between the respective mating surfaces of the U-shaped magnet 18 such that the U-shaped 18 may magnetically engage at two points on a curved surface such as a pipe or scaffold.

In another embodiment, the mounting member 16 may be comprised of a recessed pocket 28, configured to accommodate at least a curved magnet 18. In this embodiment the curved magnet comprises an inner radius of curvature matching an outer radius of curvature of a curved suitable hanging surface such that the curved magnet 18 may magnetically engage the curved surface such as a pipe or scaffold.

The magnets used in any of the embodiments discussed above may be any permanent magnetic material or permanent magnet comprised of, for example but not limited to, the following materials, ceramic, alnico, samarium cobalt or neodymium iron boron with nyodynium and samarium cobalt being preferred due to their high energy. It is beneficial, but not essential, to employ magnets having a pull force greater than about 5-8 lbs, each in order to carry a distributed load of the cables or cable bundles being placed within the helical looped wire member or spiral wire member 12.

In another embodiment, a system of multiple magnetic loop hangers 10 are used to hang the various hanging members as described above across a distance. Because the multiple magnetic loop hangers 10 are magnetic, a single loop may easily be removed or position may be changed simply by overcoming the associated magnetic attachment force and moving the device.

In another embodiment, a method for using the magnetic loop hanger 10 comprises the steps of inserting a hanging member between the pitch P of the helical looped wire member 12, rotating the magnetic loop hanger 10 such that the hanging member is bound within a circumference of the helical looped wire member 12 and magnetically engaging a suitable magnetically engageable surface such that the at least one magnet 18 attaches to the suitable magnetically engageable surface and the magnetic loop hanger 10 supports the hanging member.

An installer may use multiple magnetic loop hangers 10 when installing across a distance, and may remove the magnetic loop hanger 10 simply by overcoming the magnetic engagement force.

In another embodiment, a method for using the magnetic loop hanger 10 comprises the steps of inserting a hanging member between the pitch P of the spiral wire member 12, rotating the magnetic loop hanger 10 such that the hanging member is bound within an innermost circumference of the spiral wire member 12 and magnetically engaging a suitable magnetically engageable surface such that the at least one magnet 18 attaches to the suitable magnetically engageable surface and the magnetic loop hanger 10 supports the hanging member. An installer may use multiple magnetic loop hangers 10 when installing across a distance, and may remove the magnetic loop hanger 10 simply by overcoming the magnetic engagement force.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. A magnetic loop hanger configured to mount to a suitable magnetically engageable surface comprising:
a) a helical looped wire member having a loop opening, a central transverse axis through the loop opening, a first end and a second end, and a spaced apart opening between the first end and the second end;
b) an elongated member extending substantially normal to the central transverse axis through the loop opening from the second end of the helical looped wire member;
c) an enlarged mounting member positioned on a distal end of the elongated member;
and, d) at least one magnet coupled to the enlarged mounting member.

2. The magnetic loop hanger of claim 1 wherein the enlarged mounting member is configured to engage with a curved suitable magnetically engageable surface.

3. The magnetic loop hanger of claim 2 wherein the suitable the at least one magnet is curved and configured to engage with a curved suitable magnetically engageable surface.

4. The magnetic loop hanger of claim 2 wherein the at least one magnet and at least a second magnet each have a mating surface configured to magnetically engage the curved suitable magnetically engageable surface and the at least one magnet and the at least second magnet are coupled to the enlarged mounting member such that an angle is created between respective mating surfaces.

5. The magnetic loop hanger of claim 1 wherein the helical looped wire member, the elongated member, and the enlarged mounting member are a galvanized metal.

6. The magnetic loop hanger of claim 1 wherein the at least one magnet is a permanent magnet comprised of at least one of the following materials: ceramic, alnico, samarium cobalt or neodymium iron boron.

7. The magnetic loop hanger of claim 6 wherein a pull force of the magnet is greater than about 5-8 lbs.

8. The magnetic loop hanger of claim 1 wherein the magnet is coupled to the enlarged mounting member through an adhesive.

9. The magnetic loop hanger of claim 1 wherein the suitable magnetically engageable surface comprises any one of the following: a drop ceiling frame, an I-beam, a truss, a scaffold, piping, vents, ducts, or a sconce.

10. The magnetic loop hanger of claim 1 wherein the opening between the first end and the second end is configured to receive any one of the following: an electrical wire, a cable, conduit, or piping.

11. The magnetic loop hanger of claim 1 wherein an angle formed between the elongated member and the second end is between zero degrees and ninety degrees relative to a longitudinal axis of the elongated member.

12. The magnetic loop hanger of claim 1 wherein an angle between the elongated member and the second end is between zero degrees and negative ninety degrees relative to a longitudinal the elongated member.

13. The magnetic loop hanger of claim 1 wherein the helical looped wire member and the elongated member are physically separate components joined together.

14. The magnetic loop hanger of claim 13 wherein the helical looped wire member and the elongated member are joined together through one of the following joining means: a joining pin, a bolt, a screw, a joining bracket.

15. The magnetic loop hanger of claim 14 wherein the helical looped wire member and the elongated member are configured to translate in a longitudinal direction relative to each other and the joining means is further configured to lock the helical looped wire member and the elongated member in a translated position.

16. A method of using a magnetic loop hanger on a suitable magnetically engageable surface comprising:
a. selecting the magnetic loop hanger comprising a helical looped wire member having a loop opening, a central transverse axis through the loop opening, a first end and a second end, and a spaced apart opening between the first end and the second end, an elongated member extending from the second end of the helical looped wire member substantially normal to the central transverse axis of the loop opening, an enlarged mounting member positioned on a distal end of the elongated member, and at least one magnet coupled to the enlarged mounting member;
b. selecting a hanging member;
c. selecting a suitable magnetically engageable surface;
d. positioning the hanging member between the opening of the helical looped wire member and rotating the magnetic loop hanger such that the hanging member is bound by a circumference of the helical looped wire member; and,
e. magnetically coupling the magnetic loop hanger through the magnet to the suitable magnetically engageable surface.

17. The method of using the magnetic loop hanger of claim 16 wherein the step of selecting the suitable magnetically engageable surface includes selecting any one of the following: a drop ceiling frame, an I-beam, a truss, a scaffold, a pipe, a vent, a duct, or a sconce.

18. A magnetic loop hanger configured to mount to a suitable magnetically engageable surface comprising:
a) a spiral looped member having a loop opening, a central transverse axis through the loop opening, a first end, and a second end;
b) the first end comprising an inner starting point for which a curve of the spiral looped member outwardly winds and forms at least one revolution or successive revolutions about a center point;
c) the second end comprising an ending point for the at least one revolution or successive revolutions, wherein the second end is disposed on an outermost revolution;
d) an opening between the second end and a next inner revolution;
e) an elongated member extending substantially normal to the central transverse axis of the loop opening from the second end of the spiral looped member;
f) an enlarged mounting member positioned on a distal end of the elongated member; and
g) at least one magnet coupled to the enlarged mounting member.

19. The magnetic loop hanger of claim 18 wherein an innermost revolution of the at least one revolution or successive revolutions is configured to support at least one of the following: electrical wire, a cable, conduit, or piping.

20. The magnetic loop hanger of claim 19 wherein a pull force of the magnet is greater than about 5-8 lbs.
